(19) United States
(12) Patent Application Publication
(10) Pub. No.: US 2011/0115241 A1
(43) Pub. Date: May 19, 2011

(54) MOTOR VEHICLE FRONT ASSEMBLY COMPRISING A FRONT BUMPER SHIELD BEARING MEANS FOR ATTACHING AT LEAST ONE PIECE OF AUXILIARY EQUIPMENT OF THE MOTOR VEHICLE

(75) Inventor: VINCENT GONIN, SAINT CYR SUR LOIRE (FR)

(73) Assignee: FAURECIA BLOC AVANT, NANTERRE (FR)

(21) Appl. No.: 12/945,667

(22) Filed: Nov. 12, 2010

(30) Foreign Application Priority Data
Nov. 12, 2009 (FR) 09 57972

(51) Int. Cl. B60R 19/03; B60R 19/36; B62D 25/08

(52) U.S. Cl. 293/120; 293/146; 296/187.09

(57) ABSTRACT

This assembly is of the type comprising at least two pairs of front longitudinal members (12, 16) and supporting and attachment plates (20) positioned at the front ends of the longitudinal members (12, 16), a front bumper shield (8) comprising a one-piece frame (22) in plastic material formed with an upper bumper beam (24) and a lower bumper beam (26) and two uprights (28) connecting the upper (24) and lower (26) bumper beams, the shield (8) further comprising an additional beam (40) made with the frame (22) in the same material, said additional beam (40) comprising means for attaching at least one piece of auxiliary equipment of the motor vehicle.

### RELATED APPLICATIONS

This application claims the benefit of French Application No. 09 57972 filed Nov. 12, 2009, which is hereby expressly incorporated by reference in its entirety.

### BACKGROUND OF THE INVENTION

1. Field of the Invention

The present invention relates to a motor vehicle front assembly of the type comprising at least two pairs of front longitudinal members of a motor vehicle chassis and supporting and attachment plates positioned on the front ends of the longitudinal members.

2. Description of the Related Art

Modern motor vehicles are designed in order to suitably respond to different types of possible front impacts, such as low-speed impacts or “parking impacts,” for a speed comprised between 2.5 and 4 km/h (ECE42), medium-speed impacts or “repairable impacts,” for a speed of about 16 km/h (Danner) and high-speed impacts, for a speed comprised between 56 and 65 km/h.

Modern motor vehicles are also designed in order to protect pedestrians in the case of an impact with a pedestrian, and in particular for protecting the legs and the hip of the pedestrian.

It is possible to provide a front assembly comprising a metal upper bumper longitudinal member attached to the ends of front upper longitudinal members of a high channel (main shafts) via first metal impact absorbers added onto the upper bumper beam, and a lower bumper beam attached to the ends of front lower longitudinal members (for example cradle extensions) via second metal or plastic material impact absorbers, added on the lower bumper beam.

Nevertheless, such a front assembly is complicated and costly to manufacture and to install.

Further such an assembly is not integrated in an optimum way with the remainder of the pieces of equipment of the front portion of the motor vehicle, i.e., these pieces of equipment, such as the cooling system, the optics or other items are positioned around the front assembly without any particular connection between this assembly and these pieces of equipment. Complex attachment means then have to added for connecting these different elements with each other.

### SUMMARY OF THE INVENTION

An object of the invention is to propose a front assembly in order to suitably respond to pedestrian impacts and to low and medium speed impacts, and allowing easy integration of the other pieces of equipment of the front of the vehicle, while being simple and having low manufacturing cost.

For this purpose the invention relates to a front assembly of the aforementioned type comprising:

a front bumper shield comprising a one-piece frame in plastic material formed with an upper bumper beam and a lower bumper beam and with two uprights connecting the upper and lower bumper beams, the uprights of the frame being configured in order to act as impact absorbers and attached while bearing directly against the plates, the shield further comprising an additional beam made with the frame in the same material, said additional beam comprising attachment means for attaching at least one piece of auxiliary equipment of the motor vehicle.

According to other embodiments, the front assembly comprises one or more of the following features, taken separately or according to all the possible technical combinations:

the additional beam extends above the upper beam and comprises at least two branches extending substantially perpendicularly to the frame towards the rear of the latter, said branches comprising attachment means for attaching a piece of auxiliary equipment of the motor vehicle;

the additional beam has ribs extending at least on the front face of said beam;

the additional beam further has ribs on its upper face, said ribs further extending over the branches;

the lower beam comprises attachment means for attaching at least one piece of auxiliary equipment of the motor vehicle;

the uprights have a honeycomb structure formed with cells extending longitudinally through the uprights and opening onto the rear and/or front face of the shield;

each upright comprises first blind cells closed on the rear face side and open on the front face side, and second blind cells open on the rear face side and closed on the front face side;

the upper bumper beam is double and comprises two cross-members spaced out vertically;

the assembly further comprises a piece of auxiliary equipment extending facing the rear face of the shield, said piece of equipment being at least attached to the additional beam of said shield by said attachment means of said additional beam;

the piece of auxiliary equipment is attached to the additional beam through at least one connecting element which is attached to the attachment means of the additional beam, said connecting element being laid out so as to absorb the vibrations between the piece of auxiliary equipment and the shield.

The invention also relates to a front bumper shield for a motor vehicle of the type comprising a one-piece frame formed with an upper bumper beam and a lower bumper beam and with two uprights connecting the upper and lower bumper beams and an additional beam made with the frame in the same material, said additional beam comprising attachment means for attaching at least one piece of auxiliary equipment of the motor vehicle, the shield being provided so as to be integrated into a motor vehicle front assembly as described above, the uprights of the shield being configured in order to act as impact absorbers and adapted so as to be attached while directly bearing against the plates.

### BRIEF DESCRIPTION OF THE DRAWINGS

The invention and its advantages will be better understood upon reading the following description, only given as an example, and made with reference to the appended drawings, wherein:

FIG. 1 is a schematic exploded perspective view of a front assembly according to the invention;

FIG. 2 is a side sectional view of the assembly of FIG. 1;

FIG. 3 is a schematic perspective view of a shield of a front assembly according to a second embodiment of the invention, and

FIG. 4 is a three-quarter rear perspective view of a front assembly of FIGS. 1 and 2, a piece of auxiliary equipment being attached to the shield of said assembly.

### DETAILED DESCRIPTION OF THE PREFERRED EMBODIMENT

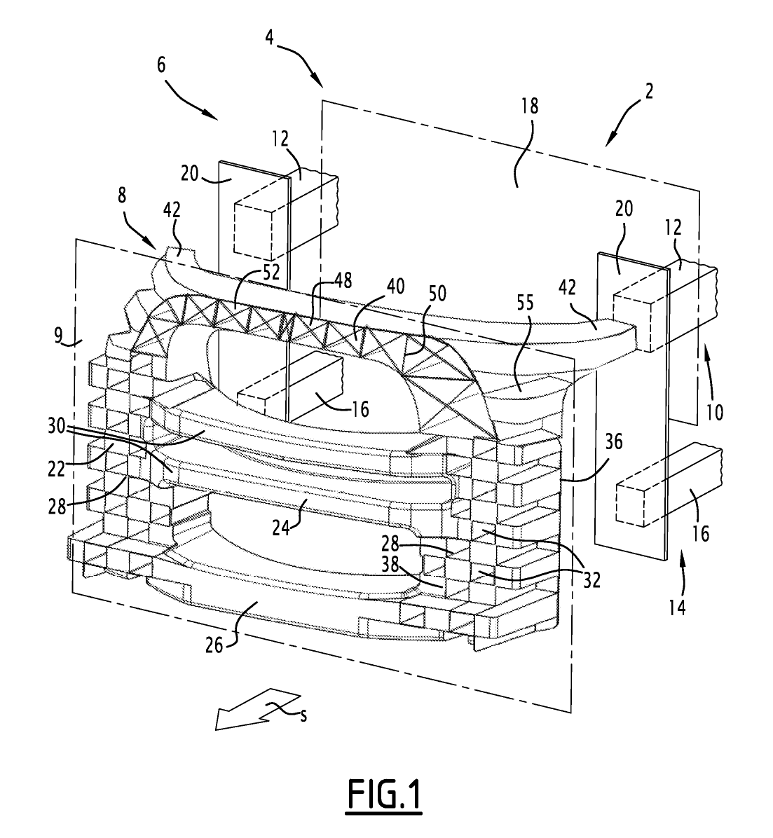

Subsequently, the orientation terms such as “longitudinal,” “transverse,” “front,” “rear,” “above,” “below,” etc. are understood with reference to the usual orientation of motor vehicles, illustrated in FIG. 1 by the arrow S directed horizontally forwards along a longitudinal direction of the motor vehicle.

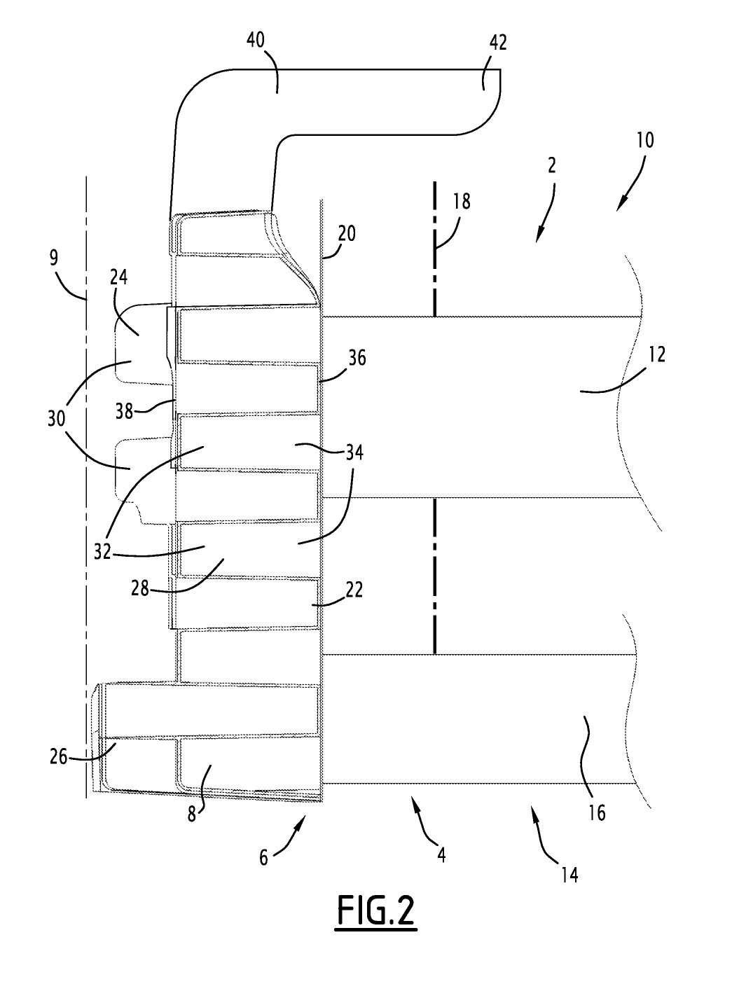

As illustrated in FIGS. 1 and 2, a motor vehicle 2 comprises a chassis 4 comprising a front portion 6, a front bumper shield 8 positioned at the front end of the front portion 6 in order to protect the front portion 6 in the case of an impact, and a bumper skin 9 for covering the shield 8.

The front portion 6 comprises a high channel 10 comprising a pair of upper longitudinal members 12 or shafts and a low channel 14 comprising a pair of lower longitudinal members 16 or cradle extensions.

The upper longitudinal members 12 extend longitudinally and are spaced out transversely from each other.

The lower longitudinal members 16 extend longitudinally and are spaced out transversely from each other. The transverse distance between the lower longitudinal members 16 is substantially equal to that between the upper longitudinal members 12.

The upper longitudinal members 12 are calibrated in order to absorb without any buckling a maximum axial force comprised between 80 kN and 100 kN. The lower longitudinal members 16 are calibrated in order to absorb without any buckling a maximum axial force comprised between 25 kN and 45 kN. On some vehicles with non average gauges, the proposed calibration ranges may slightly differ, without departing from the scope of the invention.

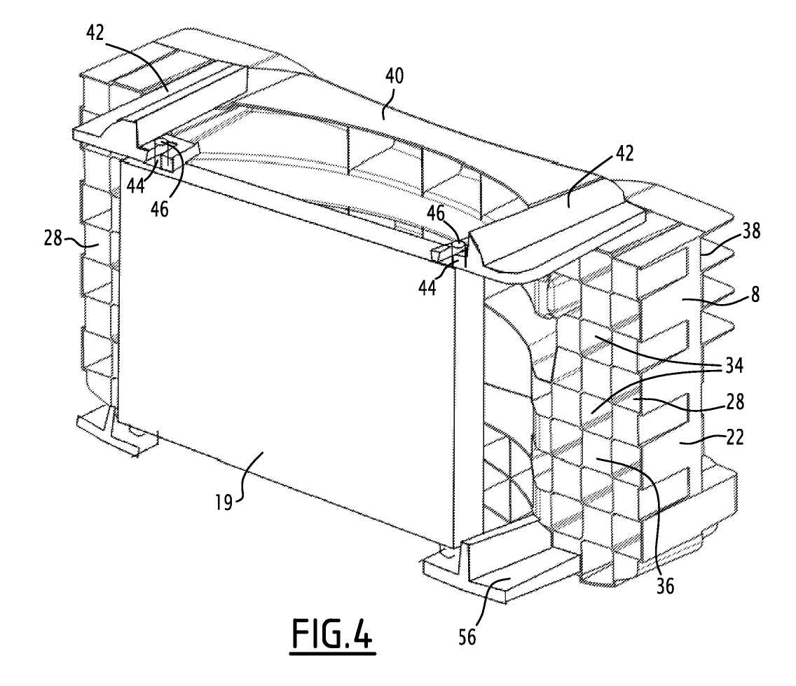

The upper longitudinal members 12 are provided in order to receive between them and to at least partly support a front face 18. The front face 18 is illustrated in FIG. 1 schematically by a rectangle in dot and dash lines. In a known way, the front face 18 comprises a supporting frame bearing functional units of a system for cooling the power train of the vehicle and/or of an air-conditioning system, such as one or more radiators or an electric fan unit. As illustrated in FIG. 4 and as this will subsequently be described, the cooling system comprises a radiator 19 attached to the shield 8.

The front face 18 is set back towards the rear of the front ends of the upper 12 and lower 16 longitudinal members.

The front portion 6 comprises a pair of attachment plates 20 positioned at the front ends of the upper 12 and lower 16 longitudinal members. Each plate 20 connects the front end of an upper longitudinal member 12 to that of the lower adjacent longitudinal member 16 located on the same side. Each plate 20 has the shape of metal plate extending in a substantially vertical transverse plane. The plates 20 may be made in pressed, rolled, folded steel or further in a light alloy.

The skin 9 is a front body element of the vehicle and defining the outer curve of the vehicle.

The shield 8 is positioned between the skin 9, by which it is covered, and the front portion 6. It has the function of absorbing energy from low speed impacts and medium speed impacts (Danner) so as to preserve the chassis 4 and to protect a pedestrian in the case of a pedestrian impact.

The shield 8 is positioned at the front ends of the upper 12 and lower 16 longitudinal members while being attached and longitudinally bearing against the plates 20. The shield 8 is positioned in front of the front face 18 so as to protect it, as well as the functional units which it bears.

The shield 8 comprises a one-piece frame 22 formed with an upper bumper beam 24 located at the height of the high channel 10, with a lower bumper beam 26 located at the height of the low channel 12 and two uprights 28 connecting the bumper beams 24, 26 to each other.

The bumper beams 24, 26 extend substantially transversely and horizontally. They are spaced out vertically from each other. The uprights 28 extend substantially vertically between the bumper beams 24, 26.

The bumper beams 24, 26 have the function of channeling the energy of an impact towards the uprights 28 in the case of a collision. The lower bumper beam 26 or “pedestrian bumper beam” also has the function of protecting the pedestrian's leg in the case of a pedestrian impact.

The lower bumper beam 26 is positioned in order to impact the leg of a pedestrian below the knee, while the upper bumper beam 26 is provided for impacting the leg of a pedestrian substantially at right angles of the knee.

The vertical amplitude of the upper bumper beam 24 is comprised between 100 mm and 200 mm, preferably between 120 mm et 150 mm, which represents a 30% to 80% increase relatively to the vertical amplitude of the conventional metal upper bumper beams, with a height conventionally comprised between 70 mm and 90 mm. The result of this is better compatibility with the knee of the pedestrian (reduced shear), because of the lower sensitivity to dispersion of the pedestrian's body (tibia size) or to the attitude of the vehicle (loading degree, braking attitude). The advantage is identical in the parking impact or low-speed compatibility impact configuration. Advantageously, the lower bumper beam 26 is more rigid and forward relatively to the upper bumper beam 24 in order to ensure suitable protection of the pedestrian.

In this example, the upper bumper beam 24 is double and comprises at least two vertically spaced parallel horizontal chord members 30. Each chord member 30 has a U section horizontally open rearwards. The chord members 30 increase the inertia of the upper bumper beam 24 when bending and twisting. They may have clearances and especially a sufficient height so that injection and stripping of the shield are facilitated (conventionally, a height comprised between 30 mm and 40 mm). Alternatively, the upper bumper beam 24 comprises a single chord member.

Optionally, each chord member 30 comprises inner stiffening longitudinal vertical ribs (not shown) for imparting to the chord member 30 the desired stiffness. In an advantageous alternative, the ribs present in the chord members 30 are distributed over the width of these chord members, so that the density of ribs per unit length upon moving along a transverse axis of the vehicle is greater in a central region of the chord member 30 relatively to the density in the side regions of the chord member 30 located on either side of the central region.

Thus, the central region for example extends on either side of the centre of the chord member 30 over a side extension of about 200 mm. This central region for example has a number of ribs of more than 4.

The presence of a large number of ribs in this central region allows, in a centered pedestrian impact, after impact of the leg of the pedestrian on this central region, a reduction in the deceleration by pure flexure of the chord members 30 over a longitudinal travel comprised between 50 mm and 70 mm. This response is radically different from the response of a conventional foam absorber which operates by pure compression over comparable travel.

Each side region extends between the central region and the uprights 28 at a distance comprised for example between 200 mm and 300 mm from the centre of the chord member 30. The number of ribs in each peripheral region is less than 4. Thus, for median pedestrian impact, when the leg of the pedestrian impacts this side region, the reduction of the deceleration is accomplished by a localized combination of flexure and compression of this region over travel close to 50 mm.

The lower bumper beam 26 has a U-section horizontally open rearwards. The lower bumper beam 26 has a greater height than that of each of the chord members 30 of the upper bumper beam 24.

Optionally, the lower bumper beam 26 comprises inner stiffening ribs (not shown) for imparting to the lower bumper beam 26 the desired stiffness as described above.

The uprights 28 of the shield 8 are provided in order to act as an energy absorber between the skin 9 and the plates 20, and for absorbing the energy of an impact on the shield 8 at low speed or medium speed (Danner).

Thus, the uprights 28 are capable of being directly attached and rigidly bearing against the plates 20, without interposing additional impact absorbers added between the uprights 28 and the plates 20.

For a motor vehicle, the mass of which is comprised between 800 and 1,200 kg, the energy to be dissipated in the case of a medium-speed impact (Danner) is generally comprised between 6 and 12 kJ, advantageously between 7 kJ and 10 kJ. Preferably, each upright 28 is provided in order to absorb energy of more than 5 kJ in the case of medium speed impact (Danner), preferably comprised between 6 and 10 kJ.

Each upright 28 has a honeycomb structure comprising cells 32, 34 extending longitudinally between a rear face 36 and a front face 38 of the uprights 28.

Each upright 28 comprises inverted blind cells comprising first blind cells 32 closed on the rear face side 36 and open on the front face side 38, and second blind cells 34 open on the rear face side 36 and closed on the front face side 28. The first cells 32 and the second cells 34 are positioned in staggered rows (or as on a checkerboard).

The shield 8 further comprises an additional beam 40 made with the frame 22 in the same material and extending above the upper beam 24 substantially parallel to the latter. The additional beam 40 comprises means for attaching at least one piece of auxiliary equipment of the motor vehicle. According to the embodiment illustrated in the figures, these attachment means are provided on a branch 42 extending to each of the ends of the additional beam 40. The branches 42 made with the additional beam in the same material, extend substantially perpendicularly to the additional beam 40 towards the rear of the frame 22. The branches 42 therefore extend along a substantially longitudinal direction towards the rear of the shield 8.

The branches 42 comprise attachment means 44, illustrated in FIG. 4, for attaching a piece of auxiliary equipment of the motor vehicle, such as a radiator 19. The attachment means are for example formed with a notch intended to receive complementary attachment means 46 provided on the radiator 19. The complementary attachment means 46 are for example formed with pins provided on the radiator and fitting into a respective notch of the branches 42. According to another embodiment, the attachment means 44 are formed with at least one orifice (not shown), on each branch 42 for receiving a complementary pin provided on the radiator 19 or a pin provided for engagement into a complementary orifice of the radiator 19. In FIGS. 1-3 the attachment means for attaching the radiator 19 are not shown and they may be of any type adapted for receiving the piece of auxiliary equipment of the motor vehicle.

According to an alternative embodiment, the radiator 19 is attached to the branches 42 via at least one connecting element (not shown) laid out so as to absorb the vibrations capable of propagating between the shield 8 and the radiator 9. This connecting element is for example made in an elastomeric material having some flexibility while having sufficient stiffness for maintaining the radiator 19 in position relatively to the shield 8. Such a connecting element is more particularly known as “silent block.” Such an element for example has an orifice for receiving a pin of the radiator 19 and an orifice for receiving a pin provided on a branch 42 of the additional beam 40 forming an attachment means 44. According to an embodiment, two connecting members are provided, each respectively attaching the radiator 19 to one of the branches 42 of the additional beam 40. According to still another embodiment, the additional beam 40 does not comprise any branch 42 and the connecting members are attached to the extreme portions of the additional beam 40.

According to alternative embodiments, the additional beam 40 further comprises attachment means for attaching other auxiliary equipment of the motor vehicle, such as means for attaching optical supports or means for attachment to wing longitudinal members provided on the body shell of the motor vehicle. The additional beam 40 may also comprise means for receiving the lock of the bonnet of the motor vehicle.

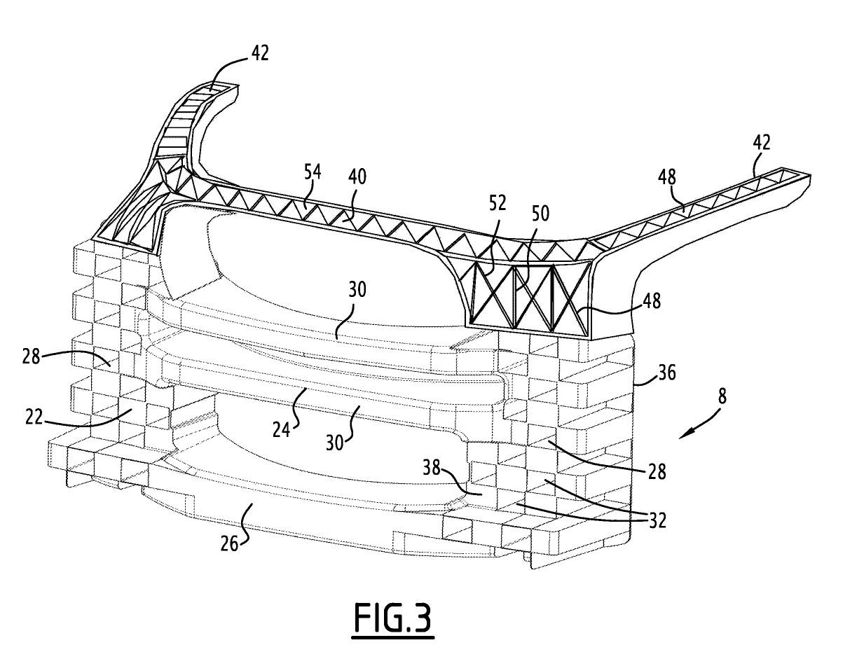

The additional beam 40 is laid out so as to exhibit some flexure along the vertical direction in order to absorb energy due to an impact on the bonnet of the motor vehicle. Further, it also has energy absorption characteristics in the case of a frontal impact against the motor vehicle. For this purpose, the additional beam 40 comprises ribs 48 extending at least on the front face of said beam 40 as illustrated in FIGS. 1 and 3. According to the embodiment illustrated in FIG. 3, the ribs 48 further extend on the upper face of the beam 40 right onto the branches 42. As illustrated in FIG. 1, the ribs 48 are for example distributed among vertical ribs 50 spaced out longitudinally from each other and ribs 52 with an “X” shape extending diagonally among the vertical ribs 50. According to the embodiment illustrated in FIG. 3, the ribs 54 of the upper face of the additional beam 40 extend as “saw teeth.”

According to the embodiment illustrated in FIG. 1, the additional beam 40 further comprises cells 55 extending the uprights 28 on the sides of the front face of the additional beam 40.

The radiator 19 illustrated in FIG. 4 is also attached to the lower beam 26 by attachment means such as connecting members 56 or “silent blocks,” described above. According to an alternative embodiment not shown, the lower beam 26 comprises uprights bearing attachment means capable of receiving complementary attachment means provided on the radiator 19.

Each upright 28 is directly attached onto the corresponding plate 20, in contact and longitudinally rigidly bearing against the plate 20. Each upright 28 covers the major portion of the supporting surface provided by the corresponding plate 20.

Each upright 28 is attached on the corresponding plate 20 by screwing or adhesive bonding.

This second solution is advantageous, insofar that it allows good distribution of the forces. Indeed, the design constraints related to the assembling by screwing (metal inserts, holes, stiffening soles, spaces for screw guns, etc.) are lifted, while the localized stresses and risks of separation caused by the screwing are very strongly attenuated. Further, the selected geometry formed of inverted blind cells positioned in staggered rows considerably increases the sizing surface at the rear of the uprights 28 and participates in a favorable distribution of the forces.

These plates 20 of great height, or giant plates, connecting each upper longitudinal member 12 to a lower longitudinal member 16, allows spreading of the distribution of the forces absorbed by the shield 8 over a significant height in the vehicle, by means of the uprights 28 extending between the high and low channels.

The giant plates 20 provide a rigid supporting surface extended to the uprights 28, which allows the uprights 28 to uniformly operate in compression in the case of an impact, without any flexure in their median portion located vertically between the high channel 10 and the low channel 14. This asset allows a homogeneous design of the uprights 28, with analogous cells uniformly spread out, which may be removed longitudinally from the mold and intended to essentially operate in compression. The architecture therefore radically differs from structures without giant plates, the uprights of which have to have a design intended for flexural operation.

Consequently, the vehicle provided with a front assembly according to the invention is less intrusive when it enters into contact with another vehicle, which is a benefit to inter-vehicular compatibility at low and medium speed.

The size of the support provided by the plates 20 is advantageously comprised between 100 and 180 mm in width and between 350 and 450 mm in height, which corresponds to surface areas globally comprised between 3.5 and 8 dm2.

The honeycomb structure of the uprights 28 facilitates manufacturing and imparts to the uprights sufficient energy absorption capacity over a small depth (the dimension along the longitudinal direction).

The frame 22 is obtained as a single block for example by injection molding of plastic material. It may be removed from the mold along a single direction corresponding to the longitudinal direction of the motor vehicle when the shield 8 is attached on the chassis 4. Thus the frame 22 may be obtained simply with low manufacturing cost. The honeycomb structure of the uprights 28 allows small or even zero clearances which limits the weight and the manufacturing cost of the shield 8. The obtained parts are therefore lightweight and show savings in material.

The honeycomb structure of the uprights also allows reduction of the local thicknesses of walls delimiting the cells 32, 34. Thus, this local thickness may be reduced in a range comprised between 2.5 and 4 mm, advantageously comprised between 3 mm and 3.5 mm.

Further, and generally, the removal of the single-piece shield 8 from the mold is facilitated since the small clearances or their absence allows its removal from the mold by the movement of two opposite half-molds in opposite directions along an axis corresponding to the longitudinal axis of the vehicle. Thus, it is not necessary to provide drawers or mobile portions in the mold.

Further, with the small or non-existent clearances in the uprights 28 as on a checkerboard, uniform stiffness may be obtained upon a longitudinal dent, for example during a medium speed impact. Thus, it is possible to obtain a substantially constant force level depending on the displacement, which increases the dissipated energy and decreases the absorption path, while remaining below the calibration force of the longitudinal members 12, 16 defined above.

The result is that the energy of an impact may be dissipated with reduced travel, and the solution proves to be very compact. This solution is therefore particularly adapted to small-engine vehicles having an impact absorption longitudinal travel of less than 250 mm, and notably less than 200 mm. The uprights 28 have a longitudinal thickness comprised between 120 and 220 mm. This allows efficient energy absorption, while limiting the cantilever of the shield 8 taken between the plates 20 and the front end of the shield 8.

Moreover, in a laterally shifted pedestrian impact, for distances notably located at more than 300 mm from the centre of the centre of the chord members 30, the reduction in deceleration is preferably accomplished by very localized pure compression of the uprights 28 as on a checkerboard over travel of about 50 mm.

The additional beam 40 further allows optimum integration of the shield 8 with the auxiliary equipment surrounding it, bearing means for attaching this equipment, while keeping a particularly simple and economical method embodiment.

It is understood that the examples and embodiments described herein are for illustrative purposes only and that various modifications or changes in light thereof will be suggested to persons skilled in the art and are to be included within the spirit and purview of this application and scope of any appended claims. All figures, tables, and appendices, as well as publications, patents, and patent applications, cited herein are hereby incorporated by reference in their entirety for all purposes.

What is claimed is:

1. A front assembly for a motor vehicle of the type comprising at least two pairs of front longitudinal members (12,16) of a chassis (4) of a motor vehicle (2) and supporting and attachment plates (20) positioned at the front ends of the longitudinal members (12, 16), wherein the assembly comprises a front bumper shield (8) comprising a one-piece frame (22) in plastic material and formed with an upper bumper beam (24) and a lower bumper beam (26) and two uprights (28) connecting the upper (24) and lower (26) bumper beams, the uprights (28) of the frame (22) being configured in order to act as impact absorbers and attached and directly bearing against the plates (20), the shield (8) further comprising an additional beam (40) made with the frame (22) in the same material, said additional beam (40) comprising attachment means for attaching at least one piece of auxiliary equipment of the motor vehicle.

2. The front assembly according to claim 1, wherein the additional beam (40) extends above the upper beam (24) and comprises at least two branches (42) extending substantially perpendicularly to the frame (22) towards the rear of the latter, said branches (42) comprising attachment means (44) for attaching a piece of auxiliary equipment of the motor vehicle.

3. The front assembly according to claim 2, wherein the additional beam (40) has ribs (48, 50, 52) extending at least on the front face of said beam (40).

4. The front assembly according to claim 3, wherein the additional beam (40) further has ribs (54) on its upper face, said ribs further extending on the branches (42).

5. The front assembly according to claim 1, wherein the lower beam (26) comprises attachment means for attaching at least one piece of auxiliary equipment of the motor vehicle.

6. The front assembly according to claim 1, wherein the uprights (28) have a honeycomb structure formed with cells extending longitudinally through the uprights (28) and opening onto the rear and/or front face of the shield (8).

7. The front assembly according to claim 6, wherein each upright (28) comprises first blind cells (32), closed on the rear face side (36) and open on the front face side (38), and second blind cells (34) open on the rear face side (36) and closed on the front face side (38).

8. The front assembly according to claim 1, wherein the upper bumper beam (24) is double and comprises two vertically spaced out cross members (30).

9. The front assembly according to claim 1, further comprising a piece of auxiliary equipment (19) extending opposite to the rear face of the shield (8), said piece of equipment being attached to at least the additional beam (40) of said shield (8) by the attachment means of said additional beam (40).

10. The front assembly according to claim 9, wherein the piece of auxiliary equipment (19) is attached to the additional beam (40) through at least one connecting member which is attached to the attachment means of the additional beam (40), said connecting member being laid out so as to absorb vibrations between the piece of auxiliary equipment (19) and the shield (8).

11. A front bumper shield for a motor vehicle, of the type comprising a one-piece frame (22) formed with an upper bumper beam (24) and a lower bumper beam (26) and two uprights (28) connecting the upper (24) and lower (26) bumper beams and an additional beam (40) made with the frame (22) in the same material, said additional beam (40) comprising attachment means for attaching at least one piece of auxiliary equipment of the motor vehicle, characterized in that it is provided in order to be integrated into a motor vehicle front assembly according to claim 1, the uprights (28) of the shield being configured so as to act as impact absorbers and adapted for being attached, directly bearing against the plates (20).
